(19) United States
(12) Patent Application Publication
(10) Pub. No.: US 2021/0316609 A1
(43) Pub. Date: Oct. 14, 2021

(54) ALL-TERRAIN VEHICLE

(71) Applicant: SEGWAY TECHNOLOGY CO., LTD., Changzhou (CN)

(72) Inventors: Dong YUAN, Changzhou (CN); Mingtang CHEN, Changzhou (CN)

(21) Appl. No.: 17/226,446

(22) Filed: Apr. 9, 2021

(30) Foreign Application Priority Data
Apr. 10, 2020 (CN) 202020532066.6

(51) Int. Cl. B60K 20/08; B60K 1/00; B60R 16/023; B60K 17/06; B60K 20/06; B60R 16/02; F16H 57/02; F16H 59/08; F16H 59/10; B60T 7/10; F16H 61/28

(52) U.S. Cl. CPC B60K 20/08; B60K 1/00; B60R 16/0238; B60K 17/06; B60K 20/06; B60R 16/0207; F16H 2059/081; F16H 59/08; F16H 59/105; B60T 7/102; F16H 61/2807; F16H 2057/02034; F16H 2057/02052; F16H 57/02

(57) ABSTRACT

An all-terrain vehicle and a gear shifting device for an all-terrain vehicle are disclosed. The all-terrain vehicle includes: a motor; a controller electrically coupled to the motor; and an electronic shifter electrically coupled to the controller. Thus, by adopting the electronic shifter, the unstable and unsmooth problem associated with purely mechanical shifting devices can be addressed, and the problems of small operation space and operation inconvenience for the drivers can be solved.

### CROSS-REFERENCE TO RELATED APPLICATION

This application is based on and claims priority to Chinese Application No. 202020532066.6, filed on Apr. 10, 2020, the entire contents of which are incorporated herein by reference for all purposes.

### FIELD

The present disclosure relates to the technical field of all-terrain vehicles, and more particularly, to an all-terrain vehicle.

### BACKGROUND

With the advancement of science and technology and the improvement of living standards, all-terrain vehicle enthusiasts have higher and higher requirements for the performance of all-terrain vehicles.

In the related art, a gearshift steering system of all-terrain vehicles is usually a purely mechanical device. However, the purely mechanical shifting device has the following problems: requiring many parts, taking up a lot of space, often failing to shift gears accurately and smoothly during installation, and being inconvenient to adjust. In addition, the purely mechanical shifting device may also affect the driver's operation on a parking brake of the vehicles.

### SUMMARY

Embodiments of a first aspect the present disclosure propose an all-terrain vehicle. The all-terrain vehicle includes: a motor; a controller electrically coupled to the motor; and an electronic shifter electrically coupled to the controller.

Embodiments of a second aspect of the present disclosure propose a gear shifting device for an all-terrain vehicle. The gear shifting device includes: a controller; and an electronic shifter electrically coupled to the controller, wherein the controller is configured to transmit shift information of the electronic shifter to a motor of the all-terrain vehicle.

Additional aspects and advantages of the present disclosure will be given in part in the following descriptions, become apparent in part from the following descriptions, or be learned from the practice of the present disclosure.

### BRIEF DESCRIPTION OF THE DRAWINGS

The above and/or additional aspects and advantages of the present disclosure will become apparent and be easily understood from the following description of the embodiments with reference to the accompanying drawings, in which:

FIG. 1 is a schematic view illustrating connection among an electronic shifter, a controller, and a motor;

FIG. 2 is a schematic view illustrating an interior of a cab.

FIG. 3 is a schematic view illustrating an all-terrain vehicle.

### DETAILED DESCRIPTION

Embodiments of the present disclosure will be described in detail below, and the embodiments described with reference to the drawings are exemplary. The embodiments of the present disclosure will be described in detail below.

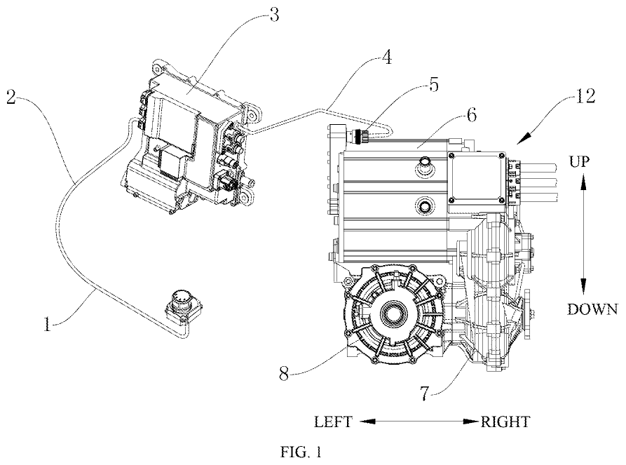

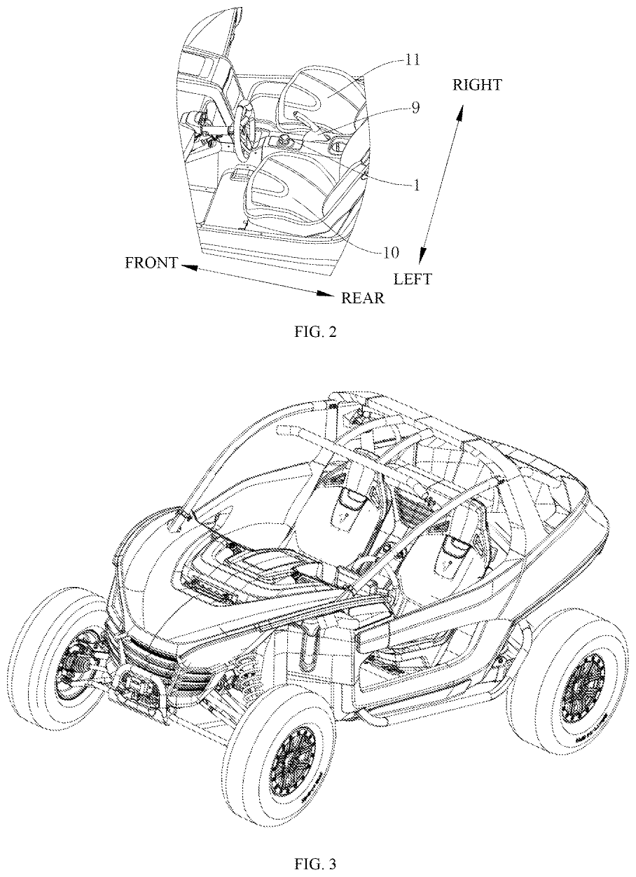

An all-terrain vehicle according to embodiments of the present disclosure will be described in detail below with reference to FIGS. 1 and 2.

As shown in FIG. 1, the all-terrain vehicle according to the embodiments of the present disclosure includes: a motor 6, a controller 3, and an electronic shifter 1. The controller 3 is electrically coupled to the motor 6, and the electronic shifter 1 is electrically coupled to the controller 3. The motor 6 provides power for the all-terrain vehicle. The controller 3 is coupled between the motor 6 and the electronic shifter 1. After a driver manipulates the electronic shifter and makes a shift action, the electronic shifter 1 can transmit shift information to the controller 3. The controller 3 converts the shift information into a shift instruction after analysis and processing, and sends the shift instruction to the motor 6, so that the motor 6 can be controlled to change output power, which can allow the output power of the motor 6 to conform to the current gear.

The all-terrain vehicle of the present disclosure adopts the electronic shifter 1, which can effectively replace traditional mechanical shift levers, thus solving the problem of unstable and unsmooth gear shifting in traditional all-terrain vehicles. Moreover, compared with the traditional mechanical shift levers, the electronic shifter 1 occupies less space, thereby avoiding interference with other components during shift operations and further ensuring shifting convenience for drivers.

In some embodiments, the all-terrain vehicle of the present disclosure may include a dashboard or a steering wheel, and the electronic shifter is arranged on the dashboard or the steering wheel.

In some embodiments, as shown in FIG. 2, the all-terrain vehicle according to the embodiments of the present disclosure further includes a cab, in which a driver seat 10 and a passenger seat 11 are arranged, and the electronic shifter 1 is arranged between the driver seat 10 and the passenger seat 11. That is, the cab includes: the passenger seat 11 and the driver seat 10, the passenger seat 11 is arranged on a front side and near a right side of the cab, and the driver seat 10 is arranged on the front side and near a left side of the cab. The electronic shifter 1 is arranged between the driver seat 10 and the passenger seat 11, such that the electronic shifter 1 is arranged in an intermediate position. As a result, the space left between the driver seat 10 and the passenger seat 11 can be reasonably used, operations of the driver can be facilitated, and the electronic shifter 1 can be prevented from interfering with the steering wheel and affecting operations of the driver.

Specifically, as shown in FIG. 2, a parking brake 9 is also arranged in the cab. The parking brake 9 is located between the driver seat 10 and the passenger seat 11 and spaced apart from the electronic shifter 1, which can further make it convenient for the driver to manipulate the parking brake 9. Moreover, since the parking brake is spaced apart from the electronic shifter, mutual interference can be avoided to a certain extent, thereby ensuring the driving safety of the driver.

Further, as shown in FIG. 2, compared with the position of the parking brake 9, the electronic shifter 1 is closer to the driver seat 10, and the parking brake 9 is located on a rear side of the electronic shifter 1. This arrangement can facilitate operations of the driver, further prevent the electronic shifter 1 and the parking brake 9 from interfering with each other, and avoid safety hazards caused by operation errors, thereby further improving the driving safety of the all-terrain vehicle.

According to a specific embodiment of the present disclosure, as shown in FIG. 1, the motor 6 includes a junction box 5. The controller 3 is electrically coupled to the junction box 5 through a CAN bus 4, and the junction box 5 is coupled to the motor 6. The arrangement of the junction box 5 can facilitate wiring, and the CAN bus 4 allows simple connection and stable transmission, which can make the shift operations more reliable.

As shown in FIG. 1, the all-terrain vehicle also includes a transmission system 12. The transmission system 12 includes: a reduction gearbox 7 and an axle 8. The axle 8 may be a rear axle, and the motor 6 is arranged above the axle 8 and the reduction gearbox 7. The reduction gearbox 7 is arranged on a side of the axle 8. A motor shaft of the motor 6 is in transmission with an input shaft of the reduction gearbox 7, and an output shaft of the reduction gearbox 7 is in transmission with the axle 8. The motor 6 is coupled to the controller 3 through the CAN bus 4, and the controller 3 is coupled to the electronic shifter 1. The driver transmits a shift signal to the controller 3 by operating the electronic shifter 1, and the controller 3 in turn processes the shift signal and transmits it to the motor 6, to change a rotation speed of the motor shaft of the motor 6. The motor shaft is in transmission with the input shaft of the reduction gearbox 7, then a rotation speed of the output shaft of the reduction gearbox 7 is changed through the reduction gearbox 7, and the output shaft of the reduction gearbox 7 is in transmission with the axle 8. As a result, the gears can be shifted.

In some embodiments, as shown in FIGS. 1 and 2, the electronic shifter 1 includes a shift knob which is used to adjust the gears more conveniently, quickly, accurately and comfortably. A top surface of the shift knob can be provided with gear letters corresponding to respective gears, such that it can be more convenient for the driver to identify and operate. For example, the word “R” on the shift knob represents a reverse gear.

Further, the shift knob is provided with an anti-slip stripe or an anti-slip surface on its periphery. The arrangement of the anti-slip stripe or anti-slip surface can avoid slipping when the driver manipulates the shift knob, and can further ensure that the driver performs shift operations accurately.

In some embodiments, the electronic shifter 1 includes a paddle shifter. That is, the all-terrain vehicle of the present disclosure can also implement shift operations in the form of paddle shifter. Moreover, the paddle shifter can make the driver's shift operation stable, convenient and fast.

In some embodiments, as shown in FIG. 1, a low-voltage cable 2 is coupled between the electronic shifter 1 and the controller 3. The low-voltage cable 2 can effectively connect the electronic shifter 1 and the controller 3, and it can stably transmit the shift information of the electronic shifter 1 to the controller 3. Moreover, the low-voltage cable 2 has a reliable structure and low cost.

Reference throughout this specification to “an embodiment,” “some embodiments,” “an exemplary embodiment”, “an example,” “a specific example,” or “some examples,” means that a particular feature, structure, material, or characteristic described in connection with the embodiment or example is included in at least one embodiment or example of the present disclosure. Thus, the above terms throughout this specification are not necessarily referring to the same embodiment or example of the present disclosure.

Although embodiments of the present disclosure have been shown and described, it would be appreciated by those skilled in the art that various changes, modifications, alternatives and variations may be made in the embodiments without departing from principles and purposes of the present disclosure. The scope of the present disclosure is defined by the claims and their equivalents.

What is claimed is:

1. An all-terrain vehicle, comprising:
a motor;
a controller electrically coupled to the motor; and
an electronic shifter electrically coupled to the controller.

2. The all-terrain vehicle according to claim 1, further comprising a dashboard or a steering wheel, the electronic shifter being arranged on the dashboard or the steering wheel.

3. The all-terrain vehicle according to claim 1, further comprising a cab, wherein a driver seat and a passenger seat are arranged in the cab, and the electronic shifter is arranged between the driver seat and the passenger seat.

4. The all-terrain vehicle according to claim 3, wherein a parking brake is also arranged in the cab, and the parking brake is spaced apart from the electronic shifter.

5. The all-terrain vehicle according to claim 4, wherein the electronic shifter is closer to the driver seat than the parking brake, and the parking brake is located on a rear side of the electronic shifter.

6. The all-terrain vehicle according to claim 1, wherein the motor comprises a junction box, and the controller is electrically coupled to the junction box through a CAN bus.

7. The all-terrain vehicle according to claim 1, further comprising a transmission system, wherein the transmission system comprises a reduction gearbox and an axle, the motor is arranged above the axle, the reduction gearbox is arranged on a side of the axle, a motor shaft of the motor is in transmission with an input shaft of the reduction gearbox, and an output shaft of the reduction gearbox is in transmission with the axle.

8. The all-terrain vehicle according to claim 1, wherein the electronic shifter comprises a shift knob.

9. The all-terrain vehicle according to claim 8, wherein the shift knob is provided with an anti-slip stripe or an anti-slip surface on a periphery of the shift knob.

10. The all-terrain vehicle according to claim 1, wherein the electronic shifter comprises a paddle shifter.

11. The aft-terrain vehicle according to claim 1, wherein a low-voltage cable is coupled between the electronic shifter and the controller.

12. The all-terrain vehicle according to claim 1, wherein the controller is coupled between the motor and the electronic shifter.

13. The all-terrain vehicle according to claim 3, wherein the passenger seat is arranged on a front side and near a right side of the cab, and the driver seat is arranged on the front side and near a left side of the cab.

14. The all-terrain vehicle according to claim 4, wherein the parking brake is located between the driver seat and the passenger seat.

15. A gear shifting device for an all-terrain vehicle, comprising:
a controller; and
an electronic shifter electrically coupled to the controller,
wherein the controller is configured to transmit shift information of the electronic shifter to a motor of the all-terrain vehicle.

16. The gear shifting device according to claim 15, wherein the electronic shifter comprises a shift knob.

17. The all-terrain vehicle according to claim 16, wherein the shift knob is provided with an anti-slip stripe or an anti-slip surface on a periphery of the shift knob.

18. The all-terrain vehicle according to claim 16, wherein the shift knob is provided with a gear letter to indicate a corresponding gear.

19. The all-terrain vehicle according to claim 15, wherein the electronic shifter comprises a paddle shifter.

20. The all-terrain vehicle according to claim 15, wherein a low-voltage cable is coupled between the electronic shifter and the controller.
